(19) United States
(12) Patent Application Publication
(10) Pub. No.: US 2006/0059010 A1
(43) Pub. Date: Mar. 16, 2006

(54) Product and price determination system

(75) Inventors: Shannon Chavis-Smith, Charlotte, NC (US); Cindy Irby, Charlotte, NC (US)

Correspondence Address: BRINKS HOFER GILSON & LIONE, P.O. BOX 10395, CHICAGO, IL, 60610, US

(73) Assignee: Amdocs Software Systems Limited

(21) Appl. No.: 11/224,497

(22) Filed: Sep. 12, 2005

Related U.S. Application Data
(60) Provisional application No. 60/609,625, filed on Sep. 14, 2004.
(60) Provisional application No. 60/609,858, filed on Sep. 14, 2004.

(51) Int. Cl. G06Q 99/00

(52) U.S. Cl. 705/1; 705/400

(57) ABSTRACT

Price structures and product structures may be associated with price structure determinants and product availability determinants. A price structure and its associated price structure determinants may define the conditions under which a price is applicable to a customer purchasing a specific product. A product structure and its associated product availability determinants may define the conditions under which a customer is eligible to obtain a product. The product availability determinants and the price structure determinants provide building blocks which may be re-used or conveniently modified to form product and price eligibility tests.

### PRIORITY CLAIM

This application claims the benefit of U.S. Provisional Application Ser. No. 60/609,625, filed Sep. 14, 2004 and U.S. Provisional Application Serial Number No. 60/609,858, filed Sep. 14, 2004, both of which are entirely incorporated herein by reference.

### BACKGROUND

1. Technical Field

This invention relates to data processing systems that determine what products are available to a customer, and at what price. In particular, this invention relates to a flexible building block system for creating sophisticated product availability and pricing rules.

2. Background Information

Past approaches to determining what products were available to a customer relied upon inflexible hardcoded processing steps, databases, and other data structures. While the product definition database might have statically captured the products that were available and the offering price at the time that the database was created, its hardcoded nature made the product definitions inflexible and often inaccurate as time went by. Expensive and time consuming re-programming processes ensued through which a software vendor manually updated the databases and programs to suit ever-changing product availabilities for service providers such as the cable TV industry.

Even if a service provider was willing to incur the re-programming expense and delay, there were other drawbacks. With every custom system release came the need for individuals to track, understand, and support the system. The past approaches increased the costs for the software and system vendor as well as the service provider and also complicated the introduction of new products, pricings, and discounts for service provider customers.

A need has long existed for addressing the problems noted above and others previously experienced.

### BRIEF SUMMARY

A service provider may employ a data processing system to establish completed price structures and components of completed price structures (e.g., price structure determinants) that may be associated with products defined for or by the service provider. Price structure definitions and their components may be employed as re-useable component building blocks for establishing a wide range of completed price structures for a wide range of products.

The price structure definitions are highly configurable by the service provider to meet the needs of the cable or satellite television industry, telephone industry, or other industries. The data processing system may also establish completed product structures including component product availability determinants. The product structures establish product eligibility (i.e., which products a customer may purchase). The price structures establish price eligibility for the products (i.e., the customer price for eligible products).

In one implementation, a data processing system establishes product availability determinants and price structure determinants to be ultimately associated with product definitions. In doing so, the data processing system may establish in a memory price structure definitions that may include a price structure identifier, and may establish in the memory price structure determinants that may specify determinant values. The data processing system may associate price structure definitions with the price structure determinants and other price structure components to form completed price structures that establish product price for any number of products represented in the product definitions. The product availability determinants may similarly be associated to a product structure to establish the eligibility criteria for a product.

The details of one or more implementations of the product and price determination system are set forth below and in the accompanying drawings. Other aspects of the product and price determination system will be apparent from the description below, including the claims.

### BRIEF DESCRIPTION OF THE DRAWINGS

FIG. 1 is an example of a product and price determination data processing system.

FIG. 2 shows an example of price structure determinants associated with a price structure, and an example of product structure determinants associated with a product structure.

FIG. 3 shows an example of a price structure and several components of the price structure.

FIG. 4 shows an example of price structure determinants which may be associated with the price structure definitions. A similar product availability determinant structure may be used for association with product definitions.

FIG. 5 is an example of the acts that may be taken by a product and price determination data processing system.

### DETAILED DESCRIPTION

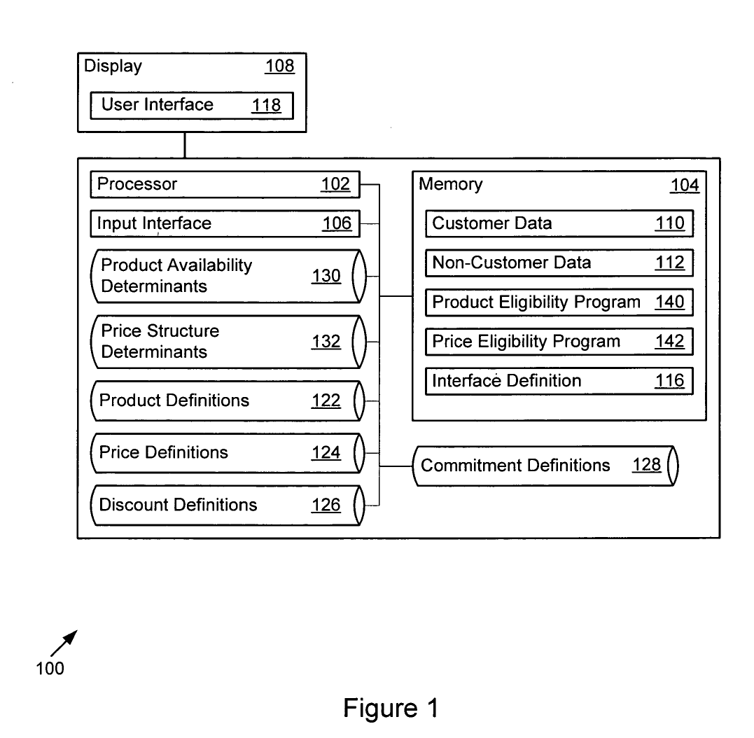

In FIG. 1, a data processing system 100 may include a processor 102, a memory 104, an input interface 106, and a display 108. The memory 104 may store customer data 110, non-customer data 112, a product eligibility program 140, and a price eligibility program 142. The memory also may include a user interface definition 116 for the user interface 118. The data processing system 100 may also include databases or data structures that define or establish product availability determinants 130 and price structure determinants 132 (including the base price structure definitions and the price structure determinant definitions discussed below), product definitions 122, price definitions 124, discount definitions 126, and commitment definitions 128.

The product definitions 122, price definitions 124, discount definitions 126, and commitment definitions 128 may be established and associated to define available products as described in U.S. Pat. App. No. 60/609,858, filed Sep. 14, 2004 titled “Product Definition System” and incorporated herein by reference in its entirety.

The elements illustrated in FIG. 1 interoperate as explained in more detail below. Before setting forth any additional explanation it is noted that all of the discussion below, regardless of the particular implementation being described, is exemplary in nature, rather than limiting. Although selected aspects, features, or components of the implementations are depicted as being stored in memory and in databases, all or part of systems and methods consistent with this invention may be stored on or read from other machine-readable media including secondary storage devices such as hard disks, floppy disks, and CD-ROMs; a received signal; or other forms of machine readable memory either currently known or later developed.

Although for discussion purposes specific components of a data processing system will be described, methods, systems, and articles of manufacture consistent with the invention may include additional or substitute different components. A processor may be a microprocessor, microcontroller, application specific integrated circuit (ASIC), discrete logic, or a combination of other types of circuits acting as explained below. A memory may be dynamic random access memory (DRAM), static random access memory (SRAM), Flash or any other type of memory. A database may be separately or remotely stored and managed, split into multiple databases, and generally logically or physically organized in many different ways. Programs may be parts, functions, or subroutines of a single program, separate programs, program libraries, or distributed across several memories and processors either locally or remotely.

The product availability determinants 130 and price structure determinants 132 may establish one or more product or price determinants or determinant groups that specify when a particular product is available and at what price. The price structures may also establish a flat price that is applicable without condition to a product. Completed price structures and product structures may be built in a flexible and extensible manner from the price structure determinants 132 and the product availability determinants 130.

A service provider may define any number of completed price structures or product structures. A service provider also may define any number of price structure determinants, product availability determinants, and determinant groups that may be components of a completed price structure or product structure. The product availability determinants 130, price structure determinants 132, completed price structures, and completed product structures may be tailored for any particular service provider in any particular industry. For example, the completed price structures may represent product price eligibility rules applicable to products offered by the cable or satellite television industry, the cellular or landline telephone industry, the publishing industry, or other industries. As examples, the completed price structures may assist a service provider with determining the price of audio programs, video programs, service products, merchandise, magazine, equipment, telephony service or product, or other products available to a given customer.

The product eligibility program 140 and price eligibility program 142 may evaluate completed product and price structures against the customer data 110 and non-customer data 112. The customer data 110 may include data representative of, characterizing, or relating to one or more customers. As examples, the customer data 110 may include account type, postal code, past due balance, credit risk, or customer type (e.g., residential or corporate). The non-customer data 112 may be any data that is not specific to any given customer, including the current time-of-day, day-of-week, or holiday (if any), transmitter characteristics, voice, video, or data coding characteristics, available bandwidth, or other data. The data 110 and 112 may be organized in other ways however, and is not limited to the examples given above.

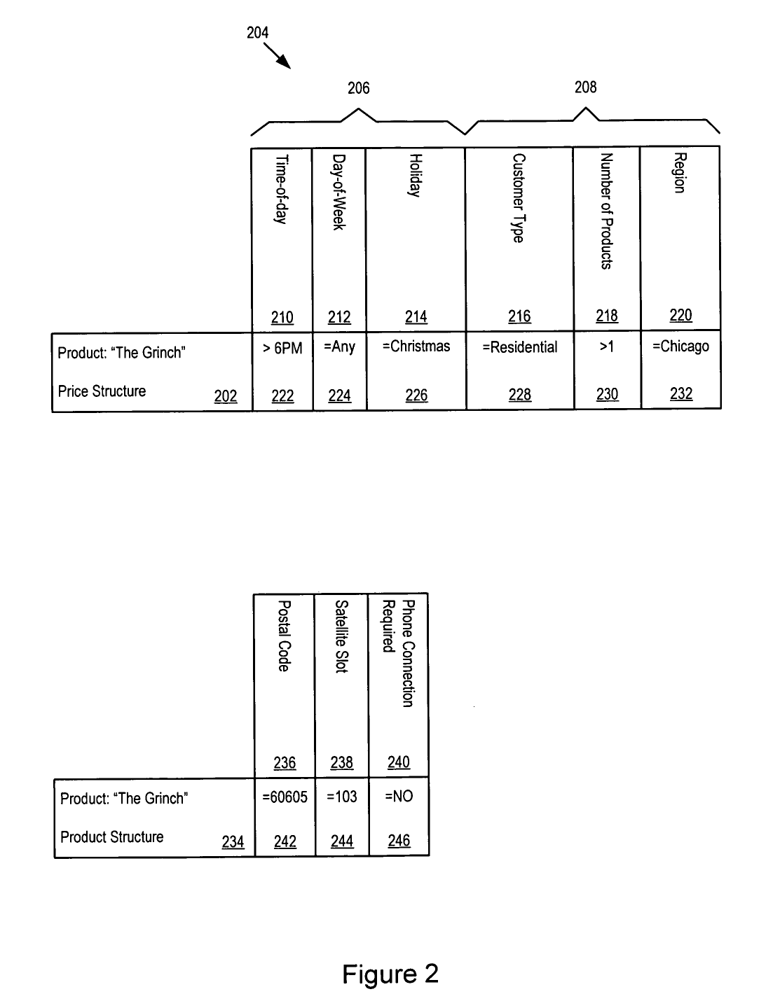

In FIG. 2 a completed price structure 202 is associated with the price structure determinants 204. The price structure determinants may include temporal determinants 206, customer characterizing determinants 208, or other types of price structure determinants. The temporal determinants 206 may include a time-of-day determinant 210, a day-of-week determinant 212, and a holiday determinant 214. The customer characterizing determinants 208 may include a customer type determinant 216, a number of products determinant 218, and a region determinant 220. Other determinants may be defined that test any defined condition, whether customer related or not.

The price structure determinants 210-220 may specify determinant tests that may be checked against the data stored in the processing system 100. The time-of-day determinant test 222 may be included in the price structure 202 to limit price availability to certain times of the day. The day-of-week determinant test 224 may be included in the price structure 202 to limit the price availability to a particular day or days of the week. The holiday determinant test 226 may be included in the price structure 202 to limit the price availability to certain holidays.

Similarly, the customer determinant test 228 may be included in the price structure 202 to limit the price eligibility to a customer type (e.g., residential or commercial). The number of products determinant test 230 may be included in the price structure 202 to limit the price eligibility to purchase of at least the number of products specified by the determinant. The region determinant test 232 may be included in the price structure 202 to limit the price eligibility based on the region in which the customer resides.

Each determinant test 222-232 may be formed from a determinant value and an operator. The determinant values may one or more numeric, string, or other values. The operators may be one or more logical or relational operators such as “=”, “>”, “<”, “< >”, “AND”, “OR”, or “NOT”. The determinant value for the time-of-day test 222, for example, is “6:00:00 PM”. The logical operator for the time-of-day test 222 is “>”. The time-of-day test 222 is passed when the current time is after 6 PM. More complicated tests may be constructed, such as the test “>6PM AND <11 PM” to test for a time between 6PM and 11 PM.

The price structure 202 may be associated with any product definition 122 and may establish at what price the product represented by the product definition is available to a customer. The data processing system 100 may treat each price structure determinant 210-220 as part of an AND condition. In other words, when each price structure determinant 210-220 is satisfied, the data processing system 100 may determine that the price structure is applicable to the customer. In other implementations, the price structure determinants may be combined with other logical relations (as examples, AND, OR, and NOT).

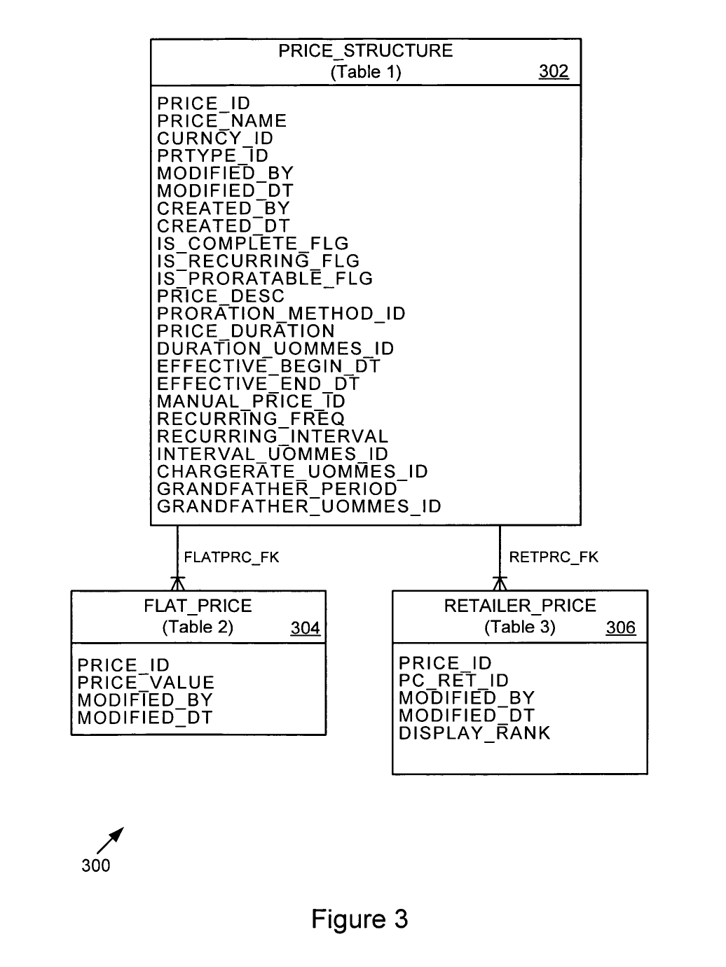

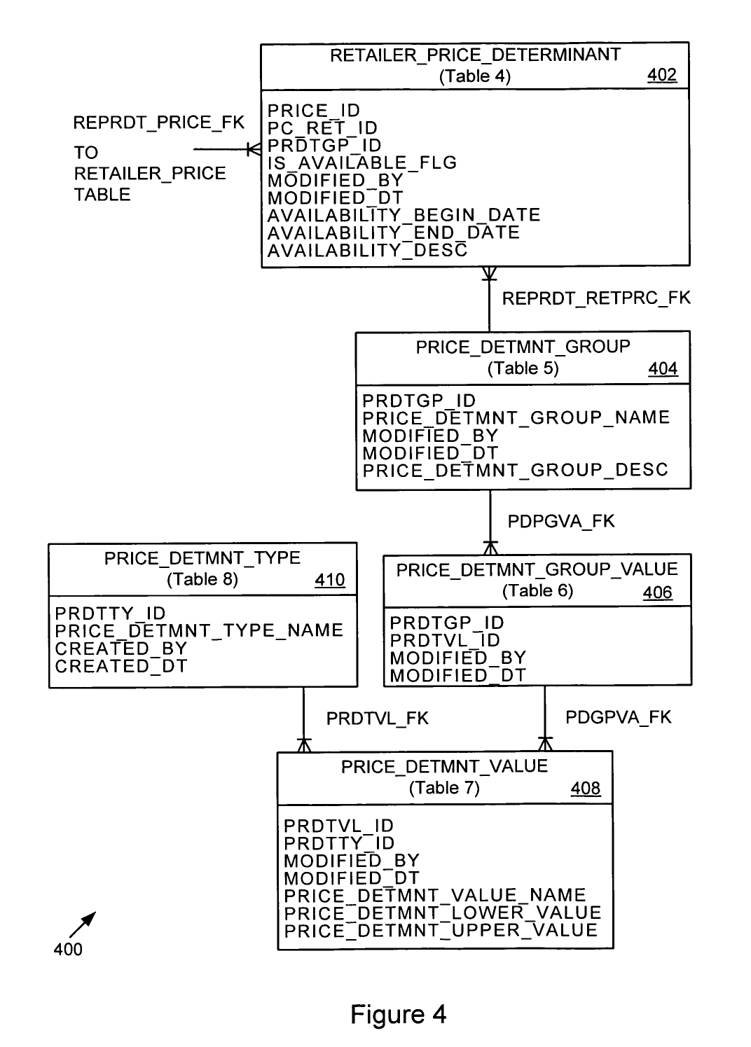

The price structure 202 as shown is associated with a cable TV product. In this case, the price structure 202 has been associated with a cable TV product: a broadcast of the animated classic “The Grinch.” As shown in FIG. 2, the price structure 202 specifies price eligibility on Christmas Day after 6 PM to any Residential customer in Chicago who purchases more than one instance of the product. The actual price for the product may be defined in the price structure discussed below and shown in FIGS. 3 and 4. Alternatively or additionally, the price for the product may be defined by the price definitions 124.

When the customer requests service, or at any other time, the price eligibility program 142 may retrieve the data 110 and 112 and evaluate the data 110 and 112 against completed price structures associated with product definitions 122 to determine the price, if any, at which products are available to a customer. The system 100 may also apply discounts as part of the price determination process explained in the Product Definition System application identified above. Because there may be any number of products and any number of price structures associated with the products, a customer may be eligible for zero, one, or many products available from a service provider.

The system 100 may establish a list or table of eligible products and their price in the memory 104. In the cable TV industry, Identifiers for each product and its price may then be transmitted through the cable connection and displayed for the customer on their television. A cable interface or television set top box may then receive a program selection from the customer and transmit the selection to the service provider.

FIG. 2 also shows a product structure 234. The product structure 234 includes product availability determinate components. The product availability determinates are associated with determinate tests. In the example shown in FIG. 2, the product structure 234 is associated with a Postal Code product availability determinant 236, a Satellite Slot product availability determinant 238, and a Phone Connection Required product availability determinant 240. The determinant test 242 tests whether the customer postal code is 60605, the determinant test 238 tests whether the customer receives satellite slot S4, and the determinant test 240 tests whether the customer needs a phone connection to be eligible for the product. In other words, the customer is eligible for “The Grinch” broadcast product, if the customer lives in postal code 60605 and is capable of receiving a signal from satellite slot 103. Any other product availability determinants or determinant tests may be implemented.

In FIG. 3, an example of base price structure definitions 300 is present. Product structures may share the same or different definitions as the price structure definitions shown in FIG. 3. The base price structure definitions 300 include a price structure table 302, a flat price table 304, and a retailer price table 306 and provide components of a completed price structure. The tables 302-306 may be implemented in a relational database or other data repository with database table fields that correspond to the table entries shown in FIG. 3. The tables 302-306 may include additional, fewer, or different fields than those shown below.

The base price structure definitions 300 include identifier fields that may be used to associate one or more individual structure definitions with one another, with products, or with other entities. Instances of the individual price structure definitions 300 may thereby form building blocks that may be assembled to provide a highly configurable and flexible pricing and availability definition system. In the examples shown in FIGS. 3 and 4, identifier fields such as a price identifier field (PRICE_ID) may be used to associate structure instances with one another to form a completed price structure for any product.

An example table definition for the price structure table 302 is shown below in Table 1. In Table 1, a primary key or portion of a concatenated primary key is marked with a ‘#’ in the Key column. Table 1 shows each database field (e.g., “PRICE_ID”), its preferred content (e.g., whether the field may be Null, or is preferably Not Null), and its type (e.g., Numeric).

TABLE 1
PRICE_STRUCTURE

| Key | Column | Content | Type |
|---|---|---|---|
| # | PRICE_ID | NOT NULL | Numeric |
| | PRICE_NAME | NOT NULL | String |
| | CURNCY_ID | NOT NULL | Numeric |
| | PRTYPE_ID | NOT NULL | Numeric |
| | MODIFIED_BY | NOT NULL | String |
| | MODIFIED_DT | NOT NULL | Date |
| | CREATED_BY | NOT NULL | String |
| | CREATED_DT | NOT NULL | Date |
| | IS_COMPLETE_FLG | NOT NULL | Numeric |
| | IS_RECURRING_FLG | NOT NULL | Numeric |
| | IS_PRORATABLE_FLG | NOT NULL | Numeric |
| | PRICE_DESC | NOT NULL | String |
| | PRORATION_METHOD_ID | NULL | Numeric |
| | PRICE_DURATION | NULL | Numeric |
| | DURATION_UOMMES_ID | NULL | Numeric |
| | EFFECTIVE_BEGIN_DT | NOT NULL | Date |
| | EFFECTIVE_END_DT | NULL | Date |
| | MANUAL_PRICE_ID | NULL | String |
| | RECURRING_FREQ | NULL | Numeric |
| | RECURRING_INTERVAL | NULL | Numeric |
| | INTERVAL_UOMMES_ID | NULL | Numeric |
| | CHARGERATE_UOMMES_ID | NOT NULL | Numeric |
| | GRANDFATHER_PERIOD | NULL | Numeric |
| | GRANDFATHER_UOMMES_ID | NULL | Numeric |

The PRICE_ID field may provide a primary key identifier of an instance of the price structure table. Many price structures, distinguished by their PRICE_ID field, may be defined in the data processing system 100 and may be associated with one or more product definitions 122. The PRICE_NAME field may provide an alphanumeric descriptor for the price structure.

The CURNCY_ID field may provide a numeric code that indicates the type of currency (e.g., dollars) that applies to the price structure. The PRTYPE_ID field may provide a numeric code which specifies the category (e.g., flat, lease, or installment) which applies to the price structure. The MODIFIED_BY field may provide an alphanumeric descriptor for the person or process that created the price structure instance. The MODIFIED_DT field may provide a date that the person or process created the price structure instance.

The IS_COMPLETE_FLG field may provide a flag that indicates whether a pre-determined set of price structure fields have been completed, or that the price structure instance meets any other pre-determined criteria before the price structure instance is available for use. The IS_RECURRING_FLG field may provide a flag that indicates whether the price structure instance represents a recurring price (e.g., once a month), or is a one-time price. The IS_PRORATABLE_FLG field may provide a flag that indicates whether the product price is pro-ratable.

The PRICE_DESC field may provide an alphanumeric descriptor for the price, including a description of how or when the price applies, for example. The PRORATION_METHOD_ID field may provide a numeric indicator of a type of pro-rating that may apply to the price (e.g., weekly or daily) when the IS_PRORATEABLE_FLG is True. The PRICE_DURATION field may provide a numeric code that may specify how long the price is available. The DURATION_UOMMES_ID field may provide a numeric code that may specify the Unit of Measure (UOM) (e.g., hours or days) that may apply to the duration.

The EFFECTIVE_BEGIN_DT field may provide a date on which the price structure may begin to apply to an associated product. The EFFECTIVE_END_DT field may provide a date after which the price structure no longer applies to an associated product. The MANUAL_PRICE_ID field may provide a user with the ability to manually define or specify a unique identifier for the price structure under construction which will serve as the primary key and which may be used to associate with price structure determinants and/or products.

The RECURRING_FREQ field may provide a numeric code that indicates how frequently (e.g., every three months) the pricing established by the price structure may apply to an associated product. The RECURRING_INTERVAL field may provide a numeric code that indicates, when the pricing applies, the time between offerings of the pricing (e.g., once every 10 days). The INTERVAL_UOMMES_ID field may provide a numeric code that may specify the Unit of Measure (UOM) (e.g., hours or days) that may apply to the interval.

The CHARGERATE_UOMMES_ID field may provide a numeric code that may specify the Unit of Measure (UOM) (e.g., days or months) that may apply to the rate at which the price is charged to the customer. The GRANDFATHER_PERIOD field may provide a numeric code that may specify a period during which a prior purchaser may continue to receive the pricing established by the price structure, after the pricing is no longer available. The GRANDFATHER_UOMMES_ID field may provide a numeric code that may specify the Unit of Measure (UOM) (e.g., months or years) that may apply to the grandfather period.

An example table definition for the flat price table 304 is shown below in Table 2.

TABLE 2
FLAT_PRICE

| Key | Column | Content | Type |
|---|---|---|---|
| # | PRICE_ID | NOT NULL | Numeric |
| | PRICE_VALUE | NOT NULL | Numeric |
| | MODIFIED_BY | NOT NULL | String |
| | MODIFIED_DT | NOT NULL | Date |

The PRICE_VALUE field provides a numeric indicator of a price associated with a price structure. The price may be associated with the price structure by storing a common identifier in the PRICE_ID field.

An example table definition for the retailer price table 306 is shown below in Table 3.

TABLE 3
RETAILER_PRICE

| Key | Column | Content | Type |
|---|---|---|---|
| # | PRICE_ID | NOT NULL | Numeric |
| # | PC_RET_ID | NOT NULL | Numeric |
| | MODIFIED_BY | NOT NULL | String |
| | MODIFIED_DT | NOT NULL | Date |
| | DISPLAY_RANK | NULL | Numeric |

The PC_RET_ID field provides a numeric indicator of a service provider that may have access to the price structure or a hierarchical definition of service providers that defines permissions to access the price structure. A service provider with access to the price structure may then employ the price structure to define pricing for its products. The DISPLAY_RANK may provide a numeric code indicating a display order or display priority for the pricing defined by the price structure. The data processing system 100 may then display the pricing options to the customer according to the display rank.

In FIG. 4, an example of determinant structure definitions 400 that may be associated with a price structure is present. The determinant structure definitions 400 include a retailer price determinant table 402, a price determinant group table 404, and a price determinant group value table 406. The structure definitions 400 also may include a price determinant value table 408 and a price determinant type table 410. The tables 402-410 may be implemented in a relational database or in other manners, and may include additional, fewer, or different fields than those shown below, depending on the implementation.

Like the base price structure definitions 300, the determinant structure definitions 400 may include identifier fields that may be used to associate one or more individual determinant structure definitions with one another, with products, or with other entities. Instances of the individual determinant structure definitions 400 may thereby form building blocks that may be assembled with the base price structure definitions 300 to provide a highly configurable and flexible product eligibility determination system and price eligibility determination system. For example, the price determinant group identifier field, PRDTGP_ID, may be used to ultimately associate a group of determinants back to a price structure through the retailer price determinant and retailer price tables.

An example table definition for the retailer price determinant table 402 is shown below in Table 4.

TABLE 4
RETAILER_PRICE_DETERMINANT

| Key | Column | Content | Type |
|---|---|---|---|
| # | PRICE_ID | NOT NULL | Numeric |
| # | PC_RET_ID | NOT NULL | Numeric |
| # | PRDTGP_ID | NOT NULL | Numeric |
| | IS_AVAILABLE_FLG | NOT NULL | Numeric |
| | MODIFIED_BY | NOT NULL | String |
| | MODIFIED_DT | NOT NULL | Date |
| | AVAILABILITY_BEGIN_DATE | NOT NULL | Date |
| | AVAILABILITY_END_DATE | NULL | Date |
| | AVAILABILITY_DESC | NOT NULL | String |

The PRDTGP_ID field may provide a numeric identifier of a price determinant group that applies to the price structure. A determinant group represents a bundle of one or more determinants into a group under a common reference identifier. A particular determinant group instance (as with the other structure definitions) may then be reused for multiple price structures without repeatedly defining the same group.

The IS_AVAILABLE_FLG may provide a flag that indicates whether the price determinant group associated with the table 402 is available for use. The data processing system 100 may set the flag when any pre-selected conditions have been met by the table 402 or associated tables 404-410. The AVAILABILITY_BEGIN_DATE field may provide a date on which the price determinant group may begin to apply to an associated price structure. The AVAILABILITY_END_DATE field may provide a date after which the determinant group no longer applies to the associated price structure. The AVAILABILITY_DESC field may provide an alphanumeric descriptor of when the determinant group will be available.

An example table definition for the price determinant group table 404 is shown below in Table 5.

TABLE 5
PRICE_DETMNT_GROUP

| Key | Column | Content | Type |
|---|---|---|---|
| # | PRDTGP_ID | NOT NULL | Numeric |
| | PRICE_DETMNT_GROUP_NAME | NOT NULL | String |
| | MODIFIED_BY | NOT NULL | String |
| | MODIFIED_DT | NOT NULL | Date |
| | PRICE_DETMNT_GROUP_DESC | NOT NULL | String |

The PRICE_DETMNT_GROUP_NAME field may provide an alphanumeric entry for the name for the determinant group specified by the PRDTGP_ID field. Similarly, the PRICE_DETMNT_GROUP_DESC field may provide an alphanumeric descriptor of the determinant group specified by the PRDTGP_ID field. The PRDTGP_ID field may associate one or more determinant values through the price determinant group value table with the determinant group.

An example table definition for the price determinant group value table 406 is shown below in Table 6.

TABLE 6
PRICE_DETMNT_GROUP_VALUE

| Key | Column | Content | Type |
|---|---|---|---|
| # | PRDTGP_ID | NOT NULL | Numeric |
| # | PRDTVL_ID | NOT NULL | Numeric |
| | MODIFIED_BY | NOT NULL | String |
| | MODIFIED_DT | NOT NULL | Date |

The PRDTVL_ID field may provide a numeric identifier of a price determinate value structure. The price determinant value structure may define one or more determinant values for a determinant test.

An example table definition for the price determinant value table 408 is shown below in Table 7.

TABLE 7
PRICE_DETMNT_VALUE

| Key | Column | Content | Type |
|---|---|---|---|
| # | PRDTVL_ID | NOT NULL | Numeric |
| | PRDTTY_ID | NOT NULL | Numeric |
| | MODIFIED_BY | NOT NULL | String |
| | MODIFIED_DT | NOT NULL | Date |
| | PRICE_DETMNT_VALUE_NAME | NOT NULL | String |
| | PRICE_DETMNT_LOWER_VALUE | NOT NULL | String |
| | PRICE_DETMNT_UPPER_VALUE | NULL | String |

Multiple instances of the price determinant value table may be created and associated, through the PRDTVL_ID field, with the price determinant group value table 406. The price determinant group value table 406, through the PRDTGP_ID field, may then bundle the determinants to a determinant group. The PRDTTY_ID may provide a numeric identifier of a price determinant type structure. The price determinant type structure may specify and desired information for a determinant.

The PRICE_DETMNT_VALUE_NAME may provide an alphanumeric name descriptor for the price determinant value established by the table 406. The PRICE_DETMNT_LOWER_VALUE may provide an alphanumeric representation for a lower value or bound (e.g., 6 PM) on a determinant value. The PRICE_DETMNT_UPPER_VALUE may provide an alphanumeric representation for an upper value or bound (e.g., 10 PM) on a determinant value. The lower value may be interpreted as part of a range, or as a single scalar value that is not part of a range.

The data processing system 100 may assume that the operator for any given determinant is “=”, and may assume that each determinant will be ANDed together to form a test. However, the table 406 (or another table) may also include an operator identifier that specifies a different operator. Similarly, the table 406 may optionally specify that way that the determinant will be joined (e.g., ANDed or ORed) with other determinants to form a test from the determinants in the determinant group.

An example table definition for the price determinant type table 410 is shown below in Table 8.

TABLE 8
PRICE_DETMNT_TYPE

| Key | Column | Content | Type |
|---|---|---|---|
| # | PRDTTY_ID | NOT NULL | Numeric |
| | PRICE_DETMNT_TYPE_NAME | NOT NULL | String |
| | MODIFIED_BY | NOT NULL | String |
| | MODIFIED_DT | NOT NULL | Date |

The PRDTTY_ID may provide a numeric identifier of a price determinant type structure that may be associated with price determinants to provide additional information for the determinants. For example, in Table 8, the PRICE_DETMNT_TYPE_NAME field may provide an alphanumeric description of the price determinant type. Other informational fields may also be provided.

As shown in FIGS. 3 and 4, one or more of the tables 302-306 and 402-410 may be related through one or more foreign keys. For example, the foreign key PRDTVK_FK relates the price determinant type table 410 to the price determinant value table 408. The foreign keys point to key fields (e.g., primary key fields) in records in other tables, and provide a mechanism to link information in different tables together.

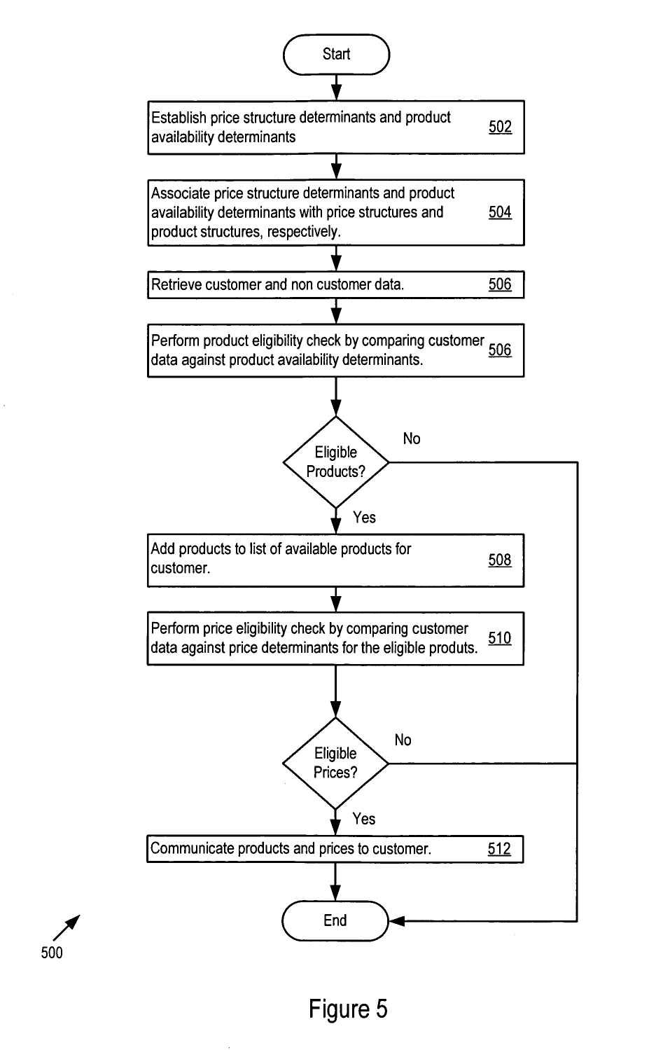

FIG. 5 shows an example of the acts that may be taken by the data processing system 100 to determine a product selection and product prices available to a customer. The data processing system 100 may establish any number of instances of product structures, price structures, product availability determinants, price availability determinants, or other components of price structures and product structures (Act 502). The data processing system 100 may then associate (e.g., through identifier fields) determinants and other components to form one or more completed price structures or product structures (Act 504).

The data processing system 100 may then retrieve the data 110, 112 (Act 506). The data processing system 100 may initiate execution of the product eligibility program 140 to compare the data 110 and 112 to the completed product structures associated with product definitions. The product eligibility program 140 may evaluate a determinant test for each product availability determinant associated with the product structure. If the product structure evaluates to True, then the product may be added to a list of products available to the customer (Act 508). Otherwise, the customer is not eligible to obtain any products, and processing may end.

If the customer is eligible to obtain any products, the processing system 100 may determine whether any eligible prices are available for the customer. To that end, the processing system 100 may initiate execution of the price eligibility program 142. The price eligibility program 142 evaluates the price structure and its constituent price structure determinants. The price eligibility program 142 thereby determines whether any of the eligible products may be purchased by the customer.

If so, the processing system communicates the eligible products and prices to the customer. For example, a cable TV service provider may communicate one or more pay-per-view program product descriptions and product prices to the customer over a satellite communication channel.

The product and price determination system provides a highly configurable and sophisticated product and price determination engine that may be employed by many service providers in many industries for their customers. Each service provider may tailor the product price determinant rules to apply across a significant range of different products by creating new determinant rules as well as new component determinants. The service provider may more easily and more efficiently develop, modify, and apply sophisticated processing designs, without the time and expense associated with obtaining custom software solutions.

It is therefore intended that the foregoing detailed description be regarded as illustrative rather than limiting, and that it be understood that it is the following claims, including all equivalents, that are intended to define the spirit and scope of this invention.

1. A method in a data processing system for establishing price eligibility for product definitions, the method comprising:
establishing a first price structure definition comprising a price structure identifier in a memory;
establishing a first price structure determinant definition comprising a determinant value identifier in the memory; and
associating the first price structure definition with the first price structure determinant definition to form a completed price structure.

2. The method of claim 1, where the act of establishing a first price structure determinant definition comprises establishing multiple price structure determinant definitions including the first price structure determinant definition.

3. The method of claim 2, further comprising grouping the multiple price structure determinant definitions together to form a determinant group.

4. The method of claim 3, where associating comprises associating the determinant group with the first price structure definition to form the completed price structure.

5. The method of claim 3, where the multiple price structure determinant definitions define a time-of-day determinant, a day-of-week determinant, a holiday determinant, a customer type determinant, a number of products determinant, or a region determinant.

6. The method of claim 1, where the first price structure determinant definition is a customer characterizing price structure determinant definition.

7. The method of claim 2, where the first price structure determinant definition is a temporal price structure determinant definition.

8. The method of claim 1, where establishing a first price structure comprises establishing at least one of an effective begin date and an effective end date.

9. A data processing system comprising:
a memory comprising:
multiple price structure definitions;
multiple price structure determinant definitions associated into determinant groups; and
a processor coupled to the memory that associates the determinant groups with at least one price structure definition to form at least one completed price structure.

10. The data processing system of claim 9, where the price structure determinant definitions comprise a determinant value.

11. The data processing system of claim 10, where the price structure determinant definitions further comprise an operator.

12. The data processing system of claim 10, where the price structure determinant definitions are combined in a logical AND test.

13. The data processing system of claim 10, where the determinant value comprises a time.

14. The data processing system of claim 10, where the determinant value comprises a region.

15. The data processing system of claim 10, where the determinant value comprises a customer type.

16. A machine readable medium encoded with instructions that cause a data processing system to perform a method for establishing price eligibility for product definitions, the method comprising:
establishing a first price structure definition comprising a price structure identifier in a memory;
establishing a first price structure determinant group definition comprising a determinant group identifier in the memory; and
associating the first price structure definition with the first price structure determinant group definition to form a completed price structure.

17. The machine readable medium of claim 16, further comprising:
establishing multiple price structure determinant definitions; and
associating the multiple price structure determinant definitions with the first price structure determinant group definition.

18. The machine readable medium of claim 17, where at least one of the multiple price structure determinant definitions comprises a determinant value.

19. The machine readable medium of claim 17, where the multiple price structure determinant definitions include a time-of-day determinant, a day-of-week determinant, or a holiday determinant.

20. The machine readable medium of claim 17, where the multiple price structure determinant definitions include a customer type determinant, a credit risk determinant, or a location determinant.

21. The machine readable medium of claim 16, where the first price structure definition comprises a effective begin date field or an effective end date field.

22. The machine readable medium of claim 16, where the first price structure definition comprises a grandfather period field.

23. The machine readable medium of claim 16, where the first price structure definition comprises a completion flag.

24. The machine readable medium of claim 16, further comprising:
establishing multiple product availability determinants in the memory;
establishing a product structure definition for a telecommunications product in the memory; and
associating the product availability determinants with the product structure to establish customer eligibility for the telecommunications product.
